(19) United States
(12) Patent Application Publication
(10) Pub. No.: US 2025/0314921 A1
(43) Pub. Date: Oct. 9, 2025

(54) PHASE MODULATION APPARATUS

(71) Applicant: SONY GROUP CORPORATION, TOKYO (JP)

(72) Inventor: YOSHIAKI KOUYAMA, TOKYO (JP)

(21) Appl. No.: 18/864,738

(22) PCT Filed: May 9, 2023
(86) PCT No.: PCT/JP2023/017439

§ 371 Date: Nov. 11, 2024

(30) Foreign Application Priority Data
May 19, 2022 (JP) 2022-082327

(51) Int. Cl. G02F 1/133

(52) U.S. Cl. CPC G02F 1/13318

(57) ABSTRACT

A phase modulation apparatus according to an embodiment of the present disclosure includes: a phase modulation device including multiple pixels and configured to modulate a phase of light from a light source; a generation section configured to generate first data on a phase modulation amount for each of the multiple pixels; and an adjustment section configured to adjust the first data to cause a phase modulation range to include a reference phase value that is based on a wavelength of light from the light source. The phase modulation device is configured to modulate the phase of light from the light source, based on the first data adjusted by the adjustment section.

### TECHNICAL FIELD

The present disclosure relates to a phase modulation apparatus.

### BACKGROUND ART

A liquid crystal display device that includes a glass substrate coated with an antireflection film and that prevents multiple reflection in a liquid crystal layer has been proposed (Patent Literature 1). In addition, a phase modulation apparatus that includes a liquid crystal has also been proposed.

### CITATION LIST

### Patent Literature

PTL 1: Japanese Unexamined Patent Application Publication No. H5-66393

### SUMMARY OF THE INVENTION

A phase modulation apparatus is desired to suppress deterioration in image quality.

It is desirable to provide a phase modulation apparatus that makes it possible to suppress deterioration in image quality.

A phase modulation apparatus according to an embodiment of the present disclosure includes: a phase modulation device including multiple pixels and configured to modulate a phase of light from a light source; a generation section configured to generate first data on a phase modulation amount for each of the multiple pixels; and an adjustment section configured to adjust the first data to cause a phase modulation range to include a reference phase value that is based on a wavelength of the light from the light source. The phase modulation device is configured to modulate a phase of the light from the light source, based on the first data adjusted by the adjustment section.

### BRIEF DESCRIPTION OF DRAWINGS

FIG. 1 is a diagram illustrating an example of a schematic configuration of a phase modulation apparatus according to a first embodiment of the present disclosure.

FIG. 2 is a diagram for describing a configuration example of a phase modulation device according to the first embodiment of the present disclosure.

FIG. 3 is a diagram illustrating an example of a relationship between a voltage applied to a pixel of the phase modulation device according to the first embodiment of the present disclosure and a phase modulation amount.

FIG. 4 is a diagram for describing an example of signal processing by the phase modulation apparatus according to the first embodiment of the present disclosure.

FIG. 5 is a diagram illustrating a configuration example of the phase modulation device according to the first embodiment of the present disclosure.

FIG. 6 is a diagram illustrating another configuration example of the phase modulation device according to the first embodiment of the present disclosure.

FIG. 7 is a diagram for describing an exemplary setting of a phase adjustment range by the phase modulation apparatus according to the first embodiment of the present disclosure.

FIG. 8 is a diagram for describing an exemplary setting of the phase adjustment range by the phase modulation apparatus according to the first embodiment of the present disclosure.

FIG. 9 is a diagram illustrating an example of a schematic configuration of a phase modulation apparatus according to a second embodiment of the present disclosure.

### MODES FOR CARRYING OUT THE INVENTION

Some embodiments of the present disclosure are described in detail below with reference to the drawings. It is to be noted that description is given in the following order.

### 1. First Embodiment

### 2. Second Embodiment

### 3. Modification Example

### 1. First Embodiment

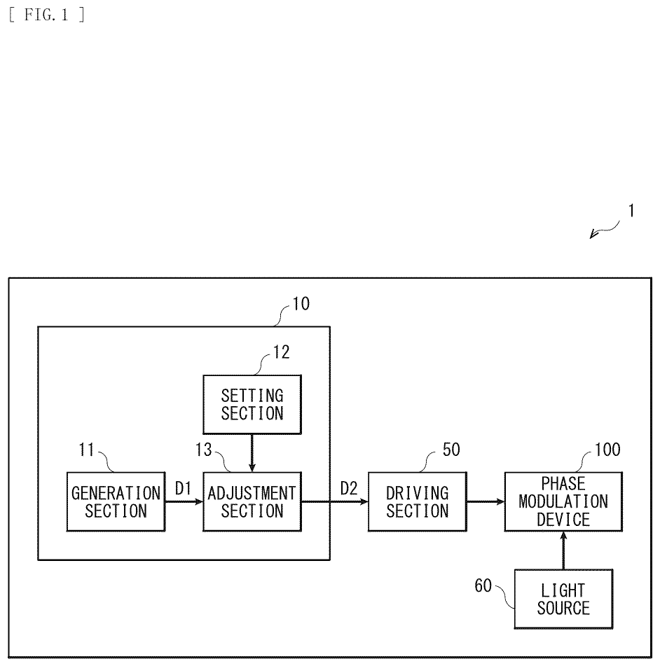

FIG. 1 is a diagram illustrating an example of a schematic configuration of a phase modulation apparatus according to a first embodiment of the present disclosure. A phase modulation apparatus 1 is a device configured to modulate a phase of light. The phase modulation apparatus 1 controls the phase of light with a phase modulation device. The phase modulation apparatus 1 may control a wavefront of light to output light of any pattern. The phase modulation apparatus 1 is applicable to various display devices and optical devices. The phase modulation apparatus 1 may be applied to, for example, a 3D displaying device, a laser processing device, a fundus examination device, an astronomical observation device, and the like.

The phase modulation apparatus 1 includes a signal processing unit 10, a driving section 50, and a phase modulation device 100. In addition, as illustrated in FIG. 1, the phase modulation apparatus 1 may include a light source 60. The signal processing unit 10 is configured to perform signal processing. The signal processing unit 10 includes, for example, a processor and a memory such as a ROM or a RAM, and performs signal processing (information processing) based on a program. The signal processing unit 10 may be also referred to as a signal processing circuit. The signal processing unit 10 may also serve as a control unit, and is configured to control each section of the phase modulation apparatus 1. For example, the signal processing unit 10 may supply a signal for controlling the driving section 50 to the driving section 50 to thereby control an operation of the driving section 50.

The signal processing unit 10 includes a generation section 11, a setting section 12, and an adjustment section 13. The generation section 11 is configured to generate data on a phase modulation amount (hereinafter, referred to as phase distribution data). The phase distribution data (phase distribution information) is data on a phase modulation amount for each pixel of the phase modulation device 100. The phase distribution data is data on a distribution of the phase modulation amounts to be set in the phase modulation device 100. In other words, the phase distribution data is data on a magnitude of a voltage (a potential difference) supplied to between electrodes of the pixels of the phase modulation device 100. The generation section 11 is a phase distribution generation section configured to generate the phase distribution data.

The generation section 11 generates phase distribution data D1, based on, for example, image data (an image signal) received from the outside. The generation section 11 may generate the phase distribution data D1 by performing a light propagation calculation using the image data. The generation section 11 calculates the phase modulation amount for each pixel necessary to display (reproduce) an image (e.g., a hologram-reproduced image) that is based on the image data, to thereby generate the phase distribution data D1 on the phase modulation amount for each pixel. The generation section 11 may be also referred to as a calculation section configured to calculate a phase distribution. The generation section 11 outputs the phase distribution data D1 thus generated to the adjustment section 13.

The setting section 12 is configured to set a setting range of the phase modulation amount of the phase modulation device 100. The setting section 12 generates data on the setting range of the phase modulation amount (hereinafter, referred to as phase setting range data). The phase setting range data is data on a settable range of the phase modulation amount of the phase modulation device 100. The setting section 12 is a phase modulation range setting section configured to set a phase modulation range.

The setting section 12 determines, for example, a median value, an upper limit value, a lower limit value, and the like of the setting range of the phase modulation amount, to thereby generate the phase setting range data indicating the median value, the upper limit value, the lower limit value, and the like of the setting range. The setting section 12 may be also referred to as a determination section configured to determine the setting range of the phase modulation amount of the phase modulation device 100. The setting section 12 outputs the phase setting range data thus generated to the adjustment section 13.

The adjustment section 13 is configured to adjust the phase distribution data. As to be described later, the adjustment section 13 adjusts the phase distribution data D1 to cause the phase modulation range to include a phase value that is based on a wavelength of light from the light source 60 (a reference phase value). The adjustment section 13 is a phase distribution adjustment section configured to adjust the phase distribution. The adjustment section 13 adjusts (corrects) the phase modulation amount for each pixel indicated by the phase distribution data D1, based on the reference phase value. The adjustment section 13 may be also referred to as a correction section configured to correct the phase distribution data. The adjustment section 13 may generate phase distribution data D2 on the distribution of the phase modulation amounts after the adjustment, and may output the phase distribution data D2 to the driving section 50.

The driving section 50 is configured to drive the phase modulation device 100. The driving section 50 is a driving device (a driving circuit), and may control an operation of the phase modulation device 100. The driving section 50 is configured to control a voltage to the phase modulation device 100, for example. The driving section 50 may supply a voltage for driving each pixel of the phase modulation device 100 to the phase modulation device 100, to thereby control the phase modulation to be performed by the phase modulation device 100.

In the example illustrated in FIG. 1, the phase distribution data D2 adjusted by the adjustment section 13 is received by the driving section 50. The driving section 50 determines a magnitude (a setting value) of a voltage to be supplied to each pixel of the phase modulation device 100, based on the phase distribution data D2, and supplies the voltage to each pixel of the phase modulation device 100. For example, the voltage to be supplied to each pixel of the phase modulation device 100 is so controlled that the distribution of the phase modulation amounts indicated by the phase distribution data D2 is obtained, which allows the phase modulation amount for each pixel to be adjusted.

The phase modulation device 100 is a device configured to modulate a phase of incident light. The phase modulation device 100 is a liquid crystal phase modulation device, and controls a phase of light from the light source 60 using a liquid crystal. It is to be noted that the phase modulation device 100 may be a transmissive liquid crystal device or a reflective liquid crystal device.

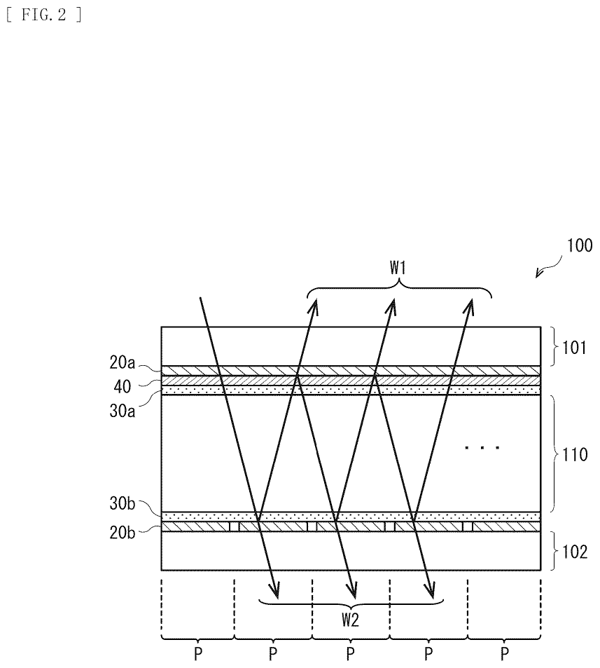

FIG. 2 is a diagram for describing a configuration example of the phase modulation device according to the first embodiment. The phase modulation device 100 includes multiple pixels P, and is configured to control the phase of light for each pixel P. In the phase modulation device 100, the multiple pixels P are provided in a two-dimensional manner. As illustrated in FIG. 1, the phase modulation device 100 includes a first substrate 101, a second substrate 102, and a liquid crystal layer 110.

The first substrate 101 and the second substrate 102 are fixed with a non-illustrated sealing material with the liquid crystal layer 110 interposed therebetween. The first substrate 101 and the second substrate 102 that are in pair are spaced apart from each other in a stacking direction. It is to be noted that respective polarizers may be disposed above the first substrate 101 and below the second substrate 102, as needed.

The first substrate 101 is a transparent substrate that transmits light, such as a glass substrate. The first substrate 101 is provided with a first electrode 20a. The second substrate 102 is disposed so as to be opposed to the first substrate 101. The second substrate 102 is, for example, a glass substrate, a semiconductor substrate (e.g., a silicon substrate), or the like. The second substrate 102 is provided with a second electrode 20b. The second electrode 20b is disposed so as to be opposed to the first electrode 20a with a portion of the liquid crystal layer 110 interposed therebetween.

The first electrode 20a is a transparent electrode that includes, for example, indium tin oxide (ITO). The first electrode 20a is an electrode common to the multiple pixels P, and may be also referred to as a counter electrode (or a common electrode).

The second electrode 20b includes a transparent material such as ITO, for example. It is to be noted that the second electrode 20b may include another metal material such as aluminum (Al). The second electrode 20b is an electrode provided for each pixel P, and may be also referred to as a pixel electrode. In addition, a device including a transistor, and wiring are formed on the second substrate 102. The second substrate 102 may be provided with circuitry for driving each pixel P.

The liquid crystal layer 110 is a layer including a plurality of liquid crystal molecules, and is provided between the first substrate 101 and the second substrate 102. The liquid crystal layer 110 is sealed between the first substrate 101 and the second substrate 102 with the sealing material. The liquid crystal molecules of the liquid crystal layer 110 having dielectric anisotropy respond to a voltage applied to between the first electrode 20a and the second electrode 20b, which achieves control of the orientation of the liquid crystal molecules.

The phase modulation device 100 further includes an antireflection film 40 and an orientation film 30 (in FIG. 2, a first orientation film 30a and a second orientation film 30b). The antireflection film 40 includes, for example, a metal oxide. In the example illustrated in FIG. 2, the antireflection film 40 is provided between the first electrode 20a and the first orientation film 30a, and reduces (suppresses) reflection. The antireflection film 40 may be provided between the second electrode 20b and the second orientation film 30b. It is to be noted that the antireflection film 40 may not be provided in the phase modulation device 100.

The orientation film 30 may cause the liquid crystal molecules of the liquid crystal layer 110 to be oriented in a specific direction. The orientation film 30 is a film (a layer) capable of controlling the orientation of the liquid crystal molecules. The orientation film 30 is, for example, a film formed by oblique vapor deposition (an oblique vapor deposition film), a polymer, or the like.

In the example illustrated in FIG. 2, the first orientation film 30a is located between the liquid crystal layer 110 and the first electrode 20a, and is provided on the first electrode 20a. The second orientation film 30b is located between the liquid crystal layer 110 and the second electrode 20b and is provided on the second electrode 20b. The liquid crystal molecules of the liquid crystal layer 110 are held in an inclined state by the first orientation film 30a and the second orientation film 30b. That is, the liquid crystal molecules of the liquid crystal layer 110 are each given a predetermined pretilt angle (inclination angle).

In the phase modulation device 100, an electric field in the liquid crystal layer 110 varies in accordance with a voltage supplied to between the first electrode 20a and the second electrode 20b, which varies the orientation of the liquid crystal molecules. The orientation of the liquid crystal molecules may be adjusted for each pixel P by controlling the voltage supplied to the second electrode 20b of each pixel P, thereby changing a refractive index and an optical path length.

Light incident on each pixel P of the phase modulation device 100 is phase-modulated in accordance with the inclination amount of the liquid crystal molecules of each pixel P before being emitted. The phase modulation device 100 causes each pixel P to occur a different phase delay with respect to the incident light, thereby propagating light having a desired wavefront.

Multiply-reflected light beams W1 illustrated in FIG. 2 schematically represent multiply-reflected light beams that are to be generated in a case where the phase modulation device 100 is a reflective liquid crystal device. In addition, multiply-reflected light beams W2 schematically represent multiply-reflected light beams that are to be generated in a case where the phase modulation device 100 is a transmissive liquid crystal device. Even in a case where the phase modulation device 100 includes the antireflection film 40, the multiply-reflected light beams are generated by multiple reflection between the first substrate 101 and the second substrate 102 depending on the wavelength or the like of the incident light, which can cause disturbance of a wavefront of emitted light.

To address this, the phase modulation apparatus 1 according to the present embodiment adjusts the phase distribution data to cause the phase modulation range of each pixel P of the phase modulation device 100 to include the reference phase value, to thereby perform the phase modulation of light using the phase modulation device 100. The reference phase value is a phase modulation amount that is set to cause light beams multiply-reflected in the phase modulation device 100 to have respective phases that are identical to each other. In the present embodiment, it is possible to reduce a phase difference between the multiply-reflected light beams. This makes it possible to suppress the disturbance of the wavefront caused by the multiply-reflected light beams.

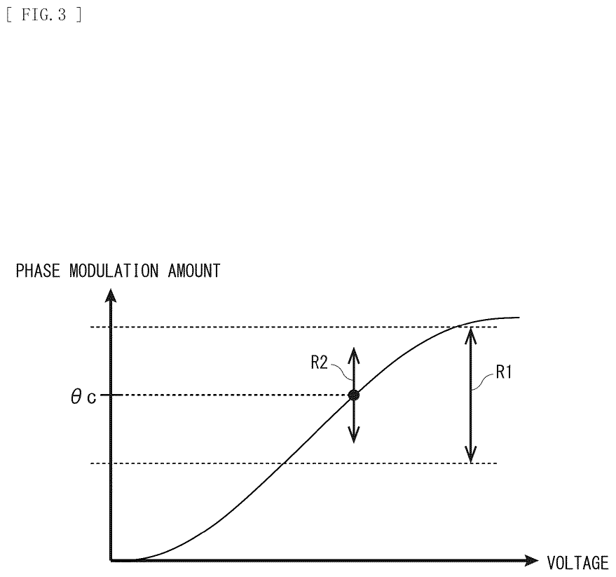

FIG. 3 is a diagram illustrating an example of a relationship between a voltage applied to the pixel of the phase modulation device according to the first embodiment and the phase modulation amount. In FIG. 3, the applied voltage is represented by a horizontal axis, and the phase modulation amount is represented by a vertical axis. A reference phase value θc illustrated in FIG. 3 is determined based on a wavelength of light incident on the phase modulation device 100. In the present embodiment, the reference phase value θc is set by the setting section 12 or the adjustment section 13, based on the wavelength of light from the light source 60, and is, for example, 0 π or 2 π.

A phase modulation range R1 illustrated in FIG. 3 is a phase modulation range indicated by the phase setting range data described above, and is a setting range of the phase modulation amount of the phase modulation device 100. The setting section 12 sets a range including the reference phase value θc, among the settable range of the phase modulation amount of the phase modulation device 100, as the phase modulation range R1, and generates the phase setting range data indicating the phase modulation range R1.

A phase modulation range R2 is a phase modulation range indicated by the phase distribution data D2 described above, and is a range of a phase modulation amount necessary to display an image. The adjustment section 13 performs shift adjustment of the phase distribution data D1 to cause the phase modulation range indicated by the phase distribution data D1 generated by the generation section 11 to include the reference phase value θc. The phase modulation range indicated by the phase distribution data D2 generated through the shift adjustment is the phase modulation range R2 including the reference phase value θc as in the example illustrated in FIG. 3.

The driving section 50 supplies a voltage to each pixel P of the phase modulation device 100 so that the phase distribution indicated by the phase distribution data D2 is obtained. Since the phase modulation amount of the phase modulation device 100 is a value within the range including the reference phase value θc, it is possible to reduce the phase difference between the light beams multiply-reflected in the phase modulation device 100. This makes it possible to suppress the occurrence of disturbance of the wavefront caused by the multiply-reflected light beams.

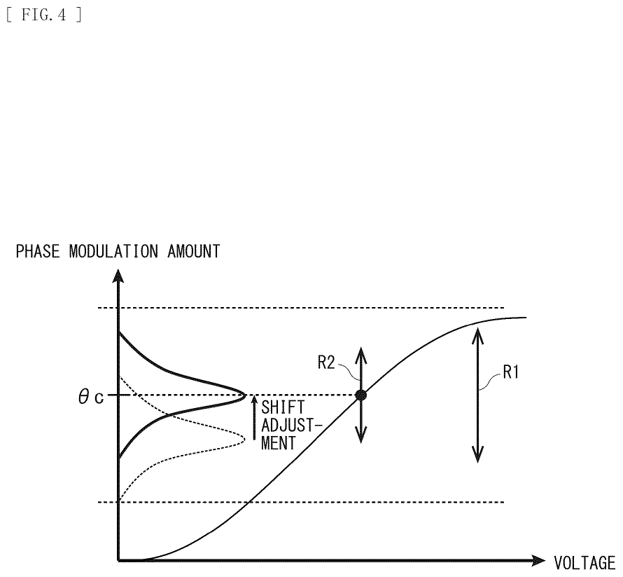

In one example, as illustrated in FIG. 4, the adjustment section 13 according to the present embodiment performs the shift adjustment of the phase modulation amount for each pixel P. The adjustment section 13 may adjust the phase distribution data D1 to reduce a difference between the phase modulation amount for each pixel P and the reference phase value θc. The adjustment section 13 may perform the shift adjustment of the phase modulation amount to reduce a sum total S1 (see the following expression (1)) of values each obtained by squaring a difference between a phase modulation amount Ψ for each pixel P and the reference phase value θc.

$$\begin{matrix}[ Expression 1 ] & \\ S 1 = {\sum }_{k = 0}^{n} {\vert {ψ}_{k} - θ c \vert}^{2} & ( 1 )\end{matrix}$$

In this case, the adjustment section 13 may adjust the phase modulation amount Ψ so that the sum total S1 is minimized. This makes it possible to reduce the difference between the phase modulation amount Ψ for each pixel Ψ and the reference phase value θc, and thus to effectively suppress the disturbance of the wavefront caused by the multiply-reflected light beams. It is thus possible to improve image quality of an image. It is to be noted that, when adjusting the phase modulation amount within the phase modulation range R1, the adjustment section 13 may perform a process of wrapping (folding back) the phase modulation amount based on the phase modulation range R1.

In one example, the generation section 11 of the phase modulation apparatus 1 is configured to generate the phase distribution data D1 by performing a light propagation calculation once. The generation section 11 may generate the phase distribution data D1 by calculating light propagation between an image plane and a reproduction plane of the phase modulation device 100 only once under a condition that a uniform phase is set as an initial phase of the reproduction plane that is an image plane formed by the light having been phase-modulated.

In this case, the generation section 11 may employ Sommerfeld diffraction integration, an angular spectral method, Fresnel diffraction, or the like, as a propagation calculation method. Further, for example, the generation section 11 may employ a double phase (DP) method, a complex field encoding (CFE) method, or the like, as a method of converting amplitude information obtained through the light propagation calculation into phase information.

The generation section 11 is capable of biasing the phase distribution of the phase distribution data D1 through the light propagation calculation described above, thereby reducing an effect of the multiple reflection on the image quality. Further, since the light propagation calculation is performed in a single step, it is possible to maintain the calculation speed at a high speed.

It is to be noted that the generation section 11 may generate the phase distribution data D1 by performing the light propagation calculation multiple times. The generation section 11 may employ a Gerchberg-Saxton method, a Wirtinger Holography method, a Stochastic Gradient Descent (SGD) method, or the like, as the propagation calculation method. The generation section 11 is capable of optimizing the phase distribution on the image plane of the phase modulation device 100 by performing the light propagation calculation at least twice.

In the case of performing the light propagation calculation multiple times also, it is possible to bias the phase distribution of the phase distribution data D1 to thereby reduce the effect of the multiple reflection on the image quality. Further, it is possible to control an extent of the phase distribution by the initial phase set at the time of the light propagation calculation, thereby improving the degree of freedom in setting. It is thus expected that the image quality is improved.

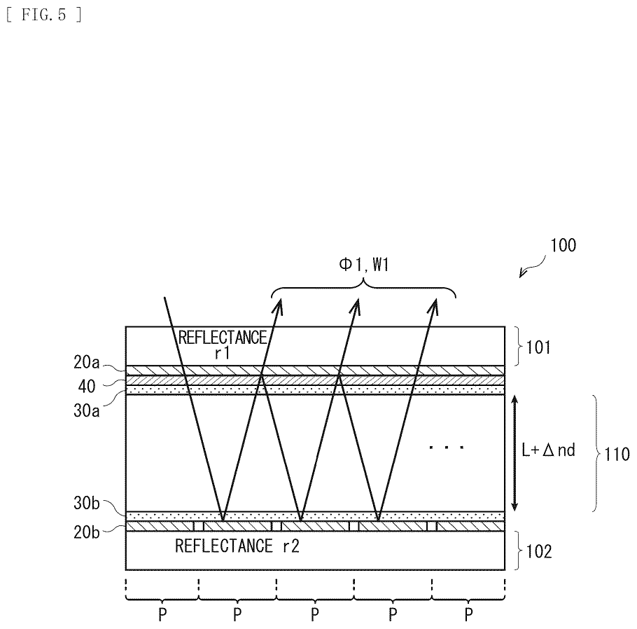

FIG. 5 is a diagram illustrating a configuration example of the phase modulation device according to the first embodiment. FIG. 5 illustrates an example in which the phase modulation device 100 is a reflective liquid crystal device. When the phase modulation has not been performed in the phase modulation device 100, an optical path length L between the first electrode 20a and the second electrode 20b may be represented by the following expression (2) using a refractive index nk of each layer and a thickness dk of each layer.

$$\begin{matrix}[ Expression 2 ] & \\ L = {\sum }_{k = 0}^{m} {n}_{k} {d}_{k} & ( 2 )\end{matrix}$$

A total phase amount θall at a certain wavelength λ may be represented by the following expression (3) using a change amount Δn of the refractive index of the liquid crystal layer 110 and a thickness d of the liquid crystal layer 110.

$$\begin{matrix}[ Expression 3 ] & \\ {θ}_{all} = 4 π ( \frac{L + Δ nd}{λ} ) & ( 3 )\end{matrix}$$

When the first electrode 20a has a refractive index r1, the second electrode 20b has a refractive index r2, and an incident wave has a phase α, a combined wave Φ1 of the multiply-reflected light beams W1 may be represented by the following expression (4).

$$\begin{matrix}[ Expression 4 ] & \\ ϕ 1 ( x , y ) = {( 1 - {r}_{1} )}^{2} {r}_{2} A ( x , y ) {e}^{ia ( x , y )} {\sum }_{k = 0}^{n} [ {r}_{1}^{k} {r}_{2}^{k} {e}^{i ( k + 1 ) {θ}_{all} ( x , y )} ] & ( 4 )\end{matrix}$$

From the expressions (3) and (4) described above, the following expression (5) is obtained. It is to be noted that m is an integer in the expression (5).

$$\begin{matrix}[ Expression 5 ] & \\ L + Δ nd = \frac{λ}{2} m & ( 5 )\end{matrix}$$

In a case where the optical path length (L+Δnd) between the substrates is an integer multiple of a half wavelength of the incident light, the combined wave Φ1 is a combination of waves having respective wavefronts that are the same as each other. This makes it possible to prevent the occurrence of disturbance of the wavefront.

In the case where the phase modulation device 100 is a reflective liquid crystal device, the setting section 12 (or the adjustment section 13) of the phase modulation apparatus 1 may set, as the reference phase value θc, such a phase modulation amount of the phase modulation device 100 that allows the optical path length between the first substrate 101 and the second substrate 102 to be an integer multiple of the half wavelength of the light from the light source 60. The above-described shift adjustment of the phase modulation amount that is based on the reference phase value θc reduces the phase difference between the multiply-reflected light beams. It is therefore possible to prevent the disturbance of the wavefront caused by the multiply-reflected light beams and to suppress deterioration in the image quality.

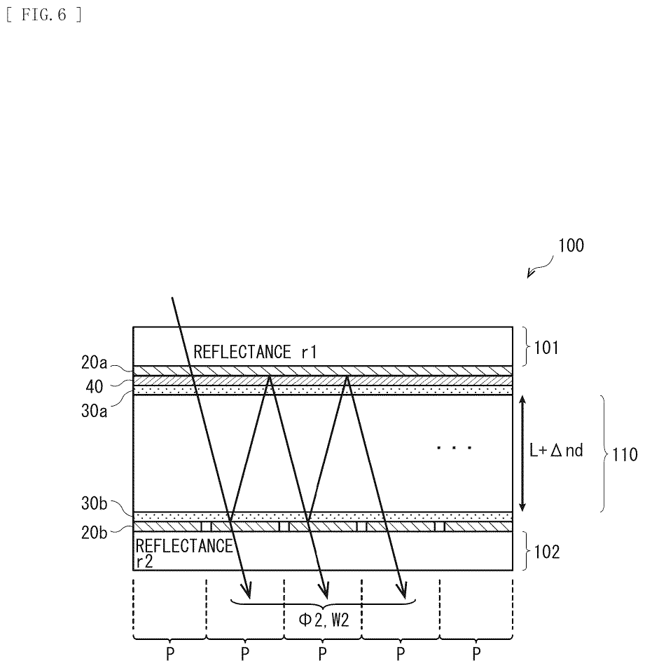

FIG. 6 is a diagram illustrating another configuration example of the phase modulation device according to the first embodiment. FIG. 6 illustrates an example in which the phase modulation device 100 is a transmissive liquid crystal device. In this case, the total phase amount θall at a certain wavelength λ may be represented by the following expression (6).

$$\begin{matrix}[ Expression 6 ] & \\ {θ}_{all} = 2 π ( \frac{L + Δ nd}{λ} ) & ( 6 )\end{matrix}$$

Further, a combined wave Φ2 of the multiply-reflected light beams W2 may be represented by the following expression (7).

$$\begin{matrix}[ Expression 7 ] & \\ ϕ 2 = ( 1 - {r}_{1} ) ( 1 - {r}_{2} ) A ( x , y ) {e}^{ia ( x , y )} {\sum }_{k = 0}^{n} [ {r}_{1}^{k} {r}_{2}^{k} {e}^{i ( 2 k + 1 ) {θ}_{all} ( x , y )} ] & ( 7 )\end{matrix}$$

From the expressions (6) and (7) described above, the following expression (8) is obtained. It is to be noted that m is an integer in the expression (8).

$$\begin{matrix}[ Expression 8 ] & \\ L + Δ nd = λ m & ( 8 )\end{matrix}$$

In a case where the optical path length (L+Δnd) between the substrates is an integer multiple of the wavelength of the incident light, the combined wave Φ2 is a combination of waves having respective wavefronts that are the same as each other. This makes it possible to prevent the occurrence of disturbance of the wavefront.

In the case where the phase modulation device 100 is a transmissive liquid crystal device, the setting section 12 (or the adjustment section 13) of the phase modulation apparatus 1 may set, as the reference phase value θc, such a phase modulation amount of the phase modulation device 100 that allows the optical path length between the first substrate 101 and the second substrate 102 to be an integer multiple of the wavelength of the light from the light source 60. The above-described shift adjustment of the phase modulation amount that is based on the reference phase value θc reduces the phase difference between the multiply-reflected light beams. It is therefore possible to prevent the disturbance of the wavefront caused by the multiply-reflected light beams and to suppress deterioration in the image quality.

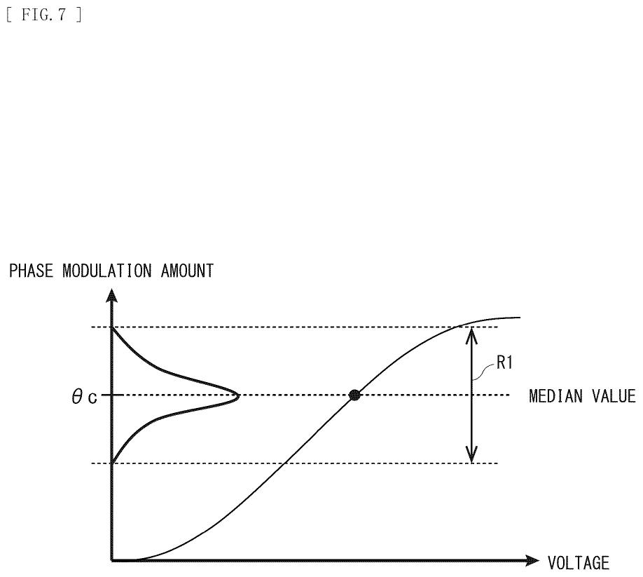

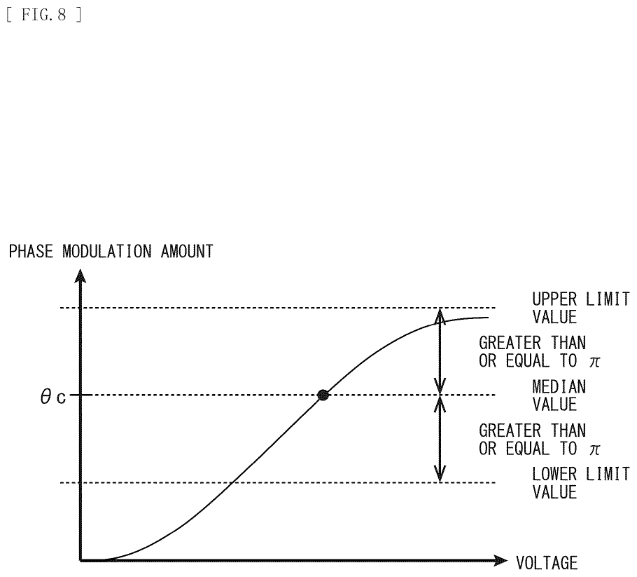

FIG. 7 and FIG. 8 are diagrams for describing an exemplary setting of the phase adjustment range by the phase modulation apparatus according to the first embodiment. The setting section 12 may set the median value of the setting range of the phase modulation amount, based on the optical path length of each pixel P. For example, the setting section 12 may set the median value of the setting range to reduce a sum total S2 (see the following expression (9)) of values each obtained by squaring the difference between a remainder obtained by dividing a phase amount θk by 2π and the reference phase value θc. The phase amount θk is based on the optical path length of each pixel P.

$$\begin{matrix}[ Expression 9 ] & \\ S 2 = {\sum }_{k = 0}^{n} {\vert {θ}_{k} ( mod 2 π ) - {θ}_{c} \vert}^{2} & ( 9 )\end{matrix}$$

In this case, the setting section 12 may set the median value of the setting range of the phase modulation amount so that the sum total S2 is minimized. This makes it possible effectively suppress the disturbance of the wavefront caused by the multiply-reflected light beams even when there is a difference in the optical path length between the pixels P of the phase modulation device 100. It is therefore possible to prevent deterioration in the image quality in a case where the optical path length of each pixel P is non-uniform.

In addition, as in the example illustrated in FIG. 8, the setting section 12 may set the setting range to allow a difference between the median value and the upper limit value of the setting range of the phase modulation amount to be a phase difference greater than or equal to the half wavelength (a phase difference greater than or equal to π). Alternatively, the setting section 12 may set the setting range to allow a difference between the median value and the lower limit value of the setting range of the phase modulation amount to be a phase difference greater than or equal to the half wavelength. This makes it possible to prevent a large potential difference from being generated between the pixels of the phase modulation device 100 and to prevent obtainment of a desired phase modulation amount from being hindered. It is possible to prevent deterioration in the image quality caused by disclination.

### [Workings and Effects]

The phase modulation apparatus according to the present embodiment (the phase modulation apparatus 1) includes: the phase modulation device (the phase modulation device 100) including the multiple pixels and configured to modulate the phase of light from the light source (the light source 60); the generation section (the generation section 11) configured to generate first data (the phase distribution data) on the phase modulation amount for each pixel, and the adjustment section (the adjustment section 13) configured to adjust the first data to cause the phase modulation range to include the reference phase value (the reference phase value θc) that is based on the wavelength of the light from the light source. The phase modulation device is configured to modulate the phase of the light from the light source, based on the first data adjusted by the adjustment section.

In the phase modulation apparatus 1 according to the present embodiment, the phase of the light from the light source 60 is modulated, based on the phase distribution data D2 adjusted such that phase modulation range includes the reference phase value θc that is based on the wavelength of the light from the light source 60. This makes it possible to suppress the occurrence of disturbance of the wavefront caused by the multiply-reflected light beams. It is thus possible to suppress deterioration in the image quality.

### 2. Second Embodiment

Next, description is given of a second embodiment of the present disclosure. Hereinafter, the same components as those in the foregoing embodiment are denoted by the same reference numerals, and description thereof is omitted as appropriate.

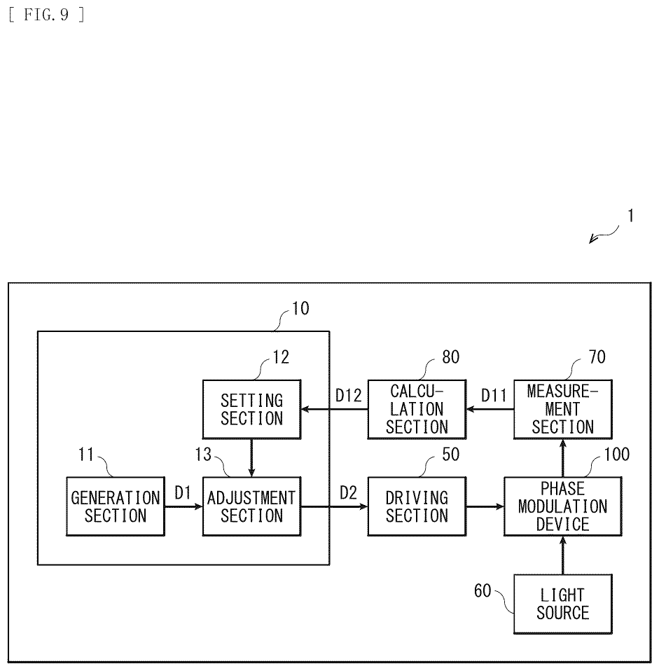

FIG. 9 is a diagram illustrating an example of a schematic configuration of a phase modulation apparatus according to the second embodiment of the present disclosure. In the present embodiment, the phase modulation apparatus 1 further includes a measurement section 70 and a calculation section 80. The measurement section 70 is configured to measure light from the phase modulation device 100. The measurement section 70 includes, for example, a photodiode sensor, a CCD image sensor, a CMOS image sensor, or the like.

The measurement section 70 is configured to photoelectrically convert incident light to thereby generate a signal. The measurement section 70 may receive the light having been phase-modulated at the phase modulation device 100, and generate and output a signal D11 that is an electric signal based on the amount of received light, as a result of measurement. For example, the measurement section 70 outputs the signal D11 corresponding to the intensity of the emitted light having been phase-modulated at the phase modulation device 100 to the calculation section 80.

The calculation section 80 is configured to calculate the phase modulation amount, based on the signal D11 received from the measurement section 70. For example, the calculation section 80 calculates (detects) a phase modulation amount θ1 of the phase modulation device 100 that allows the intensity of the light from the phase modulation device 100 to be highest, based on the signal D11. The calculation section 80 generates a signal D12 indicating the phase modulation amount θ1 thus calculated, and outputs the signal D12 to the setting section 12 of the signal processing unit 10. It is to be noted that the measurement section 70 and the calculation section 80 may be integrated. Alternatively, the signal processing unit 10 may include the calculation section 80.

The setting section 12 is configured to change the phase setting range data on the setting range of the phase modulation amount, based on the result of measurement by the measurement section 70. The setting section 12 may adjust the median value, the upper limit value, the lower limit value, and the like of the setting range of the phase modulation amount, based on the signal D12 received from the calculation section 80. For example, the setting section 12 sets the phase modulation amount θ1 indicated by the signal D12 as the median value of the setting range, to thereby adjust the phase setting range data. The setting section 12 outputs the phase setting range data thus adjusted to the adjustment section 13.

The adjustment section 13 is configured to adjust the phase distribution data, based on the result of measurement by the measurement section 70. In the example illustrated in FIG. 9, the phase setting range data changed by the setting section 12 is received by the adjustment section 13. The adjustment section 13 adjusts the phase distribution data D1, based on the phase setting range data, to thereby generate the phase distribution data D2. It is to be noted that the adjustment section 13 may change the phase distribution data D2, based on the phase setting range data. The driving section 50 supplies a voltage to each pixel P of the phase modulation device 100 so that the phase distribution indicated by the phase distribution data D2 is obtained.

As described above, in the present embodiment, the phase modulation amount of each pixel P of the phase modulation device 100 may be adjusted, based on the result of measurement by the measurement section 70. This makes it possible to adjust the phase modulation range and suppress the disturbance of the wavefront caused by the multiply-reflected light beams even when the phase modulation device 100 changes in its characteristic over time. It is therefore possible to optimize the phase modulation amount and to improve the image quality.

### [Workings and Effects]

The phase modulation apparatus according to the present embodiment (the phase modulation apparatus 1) includes the measurement section (the measurement section 70) configured to measure light from the phase modulation device (the phase modulation device 100). The adjustment section (the adjustment section 13) is configured to adjust the first data (the phase distribution data), based on the result of measurement by the measurement section.

In the phase modulation apparatus 1 according to the present embodiment, the phase distribution data is adjusted based on the result of measurement by the measurement section 70, and the phase of the light from the light source 60 is modulated. This makes it possible to suppress the occurrence of disturbance of the wavefront caused by the multiply-reflected light beams, and to suppress deterioration in the image quality.

Next, description is given of a modification example of the present disclosure. Hereinafter, the same components as those in the foregoing embodiments are denoted by the same reference numerals, and description thereof is omitted as appropriate.

### 3. Modification Example

In the foregoing embodiments, the configuration examples of the phase modulation apparatus have been described; however, the phase modulation apparatus is not limited in configuration to these examples. The phase modulation apparatus 1 may include a light source different from the light source 60, and the light source may be used as a light source for measuring the light having been phase-modulated at the phase modulation device 100. It is to be noted that a wavelength of the light from the light source for the measurement may be determined so that the light from the light source is reflected in a large amount by the electrodes (the first electrode 20a and the second electrode 20b) of the phase modulation device 100. This makes it possible to accurately measure the intensity of the light from the phase modulation device 100. It is to be noted that the light source for measurement may have a wavelength outside a wavelength range of visible light.

The phase modulation apparatus 1 may include an optical system that separates an optical path, and the optical system may measure the light from the phase modulation device 100. In addition, the measurement section 70 of the phase modulation apparatus 1 may perform the measurement using high-order diffracted light. Further, the phase modulation apparatus 1 may include, as the measurement section 70, a measurement device configured to measure a luminance distribution on the image plane of the phase modulation device 100.

In the foregoing embodiments, the configuration examples of the phase modulation device 100 have been described; however, these examples are mere examples, and the phase modulation device 100 is not limited in configuration to the examples described above. For example, the phase modulation device 100 may not include the antireflection film 40.

Although the present disclosure has been described with reference to the embodiments and the modification example, the present technology is not limited to the embodiments and the modification example described above, and various modifications may be made. For example, although the foregoing modification example has been described as a modification example of the foregoing embodiments, respective configurations of modification examples may be combined as appropriate.

The phase modulation apparatus according to any one of the embodiments of the present disclosure includes: the phase modulation device; the generation section configured to generate the first data on the phase modulation amount for each pixel; and the adjustment section configured to adjust the first data to cause the phase modulation range to include the reference phase value that is based on the wavelength of the light from the light source. The phase modulation device is configured to modulate the phase of the light from the light source, based on the first data adjusted by the adjustment section. This makes it possible to suppress the disturbance of the wavefront caused by the multiply-reflected light beams and to suppress deterioration in the image quality.

It is to be noted that the effects described herein are merely illustrative and non-limiting, and other effects may be provided. Further, the present disclosure may have the following configurations.

(1)

A phase modulation apparatus including:
a phase modulation device including multiple pixels and configured to modulate a phase of light from a light source;
a generation section configured to generate first data on a phase modulation amount for each of the multiple pixels; and
an adjustment section configured to adjust the first data to cause a phase modulation range to include a reference phase value that is based on a wavelength of the light from the light source, in which
the phase modulation device is configured to modulate the phase of the light from the light source, based on the first data adjusted by the adjustment section.
   (2)

The phase modulation apparatus according to (1), in which the reference phase value is a phase modulation amount that is set to cause light beams multiply-reflected in the phase modulation device to have respective phases that are identical to each other.

(3)

The phase modulation apparatus according to (1) or (2), in which the adjustment section is configured to adjust the first data to reduce a difference between the phase modulation amount for each of the multiple pixels and the reference phase value.

(4)

The phase modulation apparatus according to any one of (1) to (3), in which the adjustment section is configured to shift the phase modulation amount to reduce a sum total of values each obtained by squaring a difference between the phase modulation amount for each of the multiple pixels and the reference phase value.

(5)

The phase modulation apparatus according to any one of (1) to (4), in which the generation section is configured to generate the first data by performing a light propagation calculation once.

(6)

The phase modulation apparatus according to any one of (1) to (4), in which the generation section is configured to generate the first data by performing a light propagation calculation multiple times.

(7)

The phase modulation apparatus according to any one of (1) to (6), in which
the phase modulation device includes a first substrate, a second substrate opposed to the first substrate, and a liquid crystal layer provided between the first substrate and the second substrate and including a liquid crystal molecule, and
the phase modulation device is a reflective liquid crystal device.
   (8)

The phase modulation apparatus according to (7), in which the reference phase value is a phase modulation amount of the phase modulation device that allows an optical path length between the first substrate and the second substrate to be an integer multiple of a half wavelength of the light from the light source.

(9)

The phase modulation apparatus according to (7) or (8), including
a setting section configured to set a setting range of the phase modulation amount of the phase modulation device, in which
the setting section is configured to set a median value of the setting range, based on the optical path length of each of the multiple pixels.
   (10)

The phase modulation apparatus according to any one of (7) to (9), including
a setting section configured to set a setting range of the phase modulation amount of the phase modulation device, in which
the setting section is configured to set the setting range to allow a difference between a median value and an upper limit value of the setting range and a difference between the median value and a lower limit value of the setting range to each be a phase difference greater than or equal to a half wavelength.
   (11)

The phase modulation apparatus according to any one of (1) to (6), in which
the phase modulation device includes a first substrate, a second substrate opposed to the first substrate, and a liquid crystal layer provided between the first substrate and the second substrate and including a liquid crystal molecule, and
the phase modulation device is a transmissive liquid crystal device.
   (12)

The phase modulation apparatus according to (11), in which the reference phase value is a phase modulation amount of the phase modulation device that causes an optical path length between the first substrate and the second substrate to be an integer multiple of the wavelength of the light from the light source.

(13)

The phase modulation apparatus according to (11) or (12), including
a setting section configured to set a setting range of the phase modulation amount of the phase modulation device, in which
the setting section is configured to set a median value of the setting range, based on the optical path length of each of the multiple pixels.
   (14)

The phase modulation apparatus according to any one of (11) to (13), including
a setting section configured to set a setting range of the phase modulation amount of the phase modulation device, in which
the setting section is configured to set the setting range to allow a difference between a median value and an upper limit value of the setting range and a difference between the median value and a lower limit value of the setting range to each be a phase difference greater than or equal to a half wavelength.
   (15)

The phase modulation apparatus according to any one of (1) to (14), including
a measurement section configured to measure light from the phase modulation device, in which
the adjustment section is configured to adjust the first data, based on a result of measurement by the measurement section.
   (16)

The phase modulation apparatus according to any one of (1) to (15), including:
a measurement section configured to measure light from the phase modulation device; and
a setting section configured to set a setting range of a phase modulation amount of the phase modulation device, in which
the setting section is configured to set the setting range, based on a result of measurement by the measurement section.
   (17)

The phase modulation apparatus according to any one of (1) to (16), including:
a measurement section configured to measure light from the phase modulation device; and
a setting section configured to set a setting range of a phase modulation amount of the phase modulation device, in which
the setting section is configured to set, as a median value of the setting range, the phase modulation amount of the phase modulation device that allows intensity of light from the phase modulation device to be highest.

This application claims the priority on the basis of Japanese Patent Application No. 2022-082327 filed on May 19, 2022, with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A phase modulation apparatus comprising:
a phase modulation device including multiple pixels and configured to modulate a phase of light from a light source;
a generation section configured to generate first data on a phase modulation amount for each of the multiple pixels; and
an adjustment section configured to adjust the first data to cause a phase modulation range to include a reference phase value that is based on a wavelength of the light from the light source, wherein
the phase modulation device is configured to modulate the phase of the light from the light source, based on the first data adjusted by the adjustment section.

2. The phase modulation apparatus according to claim 1, wherein the reference phase value comprises a phase modulation amount that is set to cause light beams multiply-reflected in the phase modulation device to have respective phases that are identical to each other.

3. The phase modulation apparatus according to claim 1, wherein the adjustment section is configured to adjust the first data to reduce a difference between the phase modulation amount for each of the multiple pixels and the reference phase value.

4. The phase modulation apparatus according to claim 1, wherein the adjustment section is configured to shift the phase modulation amount to reduce a sum total of values each obtained by squaring a difference between the phase modulation amount for each of the multiple pixels and the reference phase value.

5. The phase modulation apparatus according to claim 1, wherein the generation section is configured to generate the first data by performing a light propagation calculation once.

6. The phase modulation apparatus according to claim 1, wherein the generation section is configured to generate the first data by performing a light propagation calculation multiple times.

7. The phase modulation apparatus according to claim 1, wherein
the phase modulation device includes a first substrate, a second substrate opposed to the first substrate, and a liquid crystal layer provided between the first substrate and the second substrate and including a liquid crystal molecule, and
the phase modulation device comprises a reflective liquid crystal device.

8. The phase modulation apparatus according to claim 7, wherein the reference phase value comprises a phase modulation amount of the phase modulation device that allows an optical path length between the first substrate and the second substrate to be an integer multiple of a half wavelength of the light from the light source.

9. The phase modulation apparatus according to claim 8, comprising
a setting section configured to set a setting range of the phase modulation amount of the phase modulation device, wherein
the setting section is configured to set a median value of the setting range, based on the optical path length of each of the multiple pixels.

10. The phase modulation apparatus according to claim 8, comprising
a setting section configured to set a setting range of the phase modulation amount of the phase modulation device, wherein
the setting section is configured to set the setting range to allow a difference between a median value and an upper limit value of the setting range and a difference between the median value and a lower limit value of the setting range to each be a phase difference greater than or equal to a half wavelength.

11. The phase modulation apparatus according to claim 1, wherein
the phase modulation device includes a first substrate, a second substrate opposed to the first substrate, and a liquid crystal layer provided between the first substrate and the second substrate and including a liquid crystal molecule, and
the phase modulation device comprises a transmissive liquid crystal device.

12. The phase modulation apparatus according to claim 11, wherein the reference phase value comprises a phase modulation amount of the phase modulation device that allows an optical path length between the first substrate and the second substrate to be an integer multiple of the wavelength of the light from the light source.

13. The phase modulation apparatus according to claim 12, comprising
a setting section configured to set a setting range of the phase modulation amount of the phase modulation device, wherein
the setting section is configured to set a median value of the setting range, based on the optical path length of each of the multiple pixels.

14. The phase modulation apparatus according to claim 12, comprising
a setting section configured to set a setting range of the phase modulation amount of the phase modulation device, wherein
the setting section is configured to set the setting range to allow a difference between a median value and an upper limit value of the setting range and a difference between the median value and a lower limit value of the setting range to each be a phase difference greater than or equal to a half wavelength.

15. The phase modulation apparatus according to claim 1, comprising
a measurement section configured to measure light from the phase modulation device, wherein
the adjustment section is configured to adjust the first data, based on a result of measurement by the measurement section.

16. The phase modulation apparatus according to claim 1, comprising:
a measurement section configured to measure light from the phase modulation device; and
a setting section configured to set a setting range of a phase modulation amount of the phase modulation device, wherein
the setting section is configured to set the setting range, based on a result of measurement by the measurement section.

17. The phase modulation apparatus according to claim 1, comprising:
a measurement section configured to measure light from the phase modulation device; and
a setting section configured to set a setting range of a phase modulation amount of the phase modulation device, wherein
the setting section is configured to set, as a median value of the setting range, the phase modulation amount of the phase modulation device that allows intensity of light from the phase modulation device to be highest.
